(19) United States
(12) Patent Application Publication
(10) Pub. No.: US 2014/0252284 A1
(43) Pub. Date: Sep. 11, 2014

(54) Load-Handling Device

(71) Applicant: Thomas D. Wagatha, Westland, MI (US)

(72) Inventor: Thomas D. Wagatha, Westland, MI (US)

(21) Appl. No.: 13/793,253

(22) Filed: Mar. 11, 2013

(51) Int. Cl. A01G 23/099; B66D 1/60

(52) U.S. Cl. CPC A01G 23/099; B66D 1/60
USPC 254/262

(57) ABSTRACT

A load-handling device for lowering a limb from a tree comprising a base having an elongated plate, at least one cylindrical protuberance secured to the base, and a plurality of non-penetrable teeth extending outward from the base toward the trunk of the tree. The load-handling device also includes at least one pair of opposed brackets that can be engaged by a strap encircling the trunk of the tree. The non-penetrable teeth frictionally engage the load-handling device against the tree so that the device does not move when the tree limb is cut and the weight of the limb pulls upwardly on the load-handling device via a pulley.

### BACKGROUND OF THE INVENTION

1. Field of the Invention

The present invention pertains to a load-handling device. More particularly, the present invention pertains to a load-handing device for use by arborists in lowering tree limbs from a tree.

2. Description of the Prior Art

Arborists frequently encounter the need to sever tree limbs from trees under circumstances in which the limbs are diseased or damaged, for example. A rope, or line, may be used to lower the limb to the ground after it is severed. A first end of the rope is tied to the limb which is to be severed and trained over one or more overhead limbs. Preferably, the rope is trained through a pulley or similar device. The remaining portion of the rope may be wrapped around the trunk of the tree one or multiple times, and the second end of the rope may be gripped by the arborist. Accordingly, as the severed tree limb is lowered to the ground, the trunk and overhead limbs of the tree apply friction to the rope to slow or control the rate of descent of the severed limb and prevent the limb from crashing to the ground.

However, wrapping the rope around the tree and sliding it tautly over the coarse tree bark is very damaging to the rope. Specialized ropes used by arborists are expensive, and it is critical that the ropes are not damaged in this manner. In addition, the damage inflicted upon the ropes can also cause the ropes to break, which can be extremely dangerous.

There are several related friction brakes or load-handling devices disclosed in the prior art intended to address this problem. For example, there exists U.S. Pat. No. 4,239,188 to Hobbs; U.S. Pat. No. 6,631,885 to Halas; and U.S. Pat. No. 4,239,188 to Hobbs U.S. Pat. No. 8,292,041 to Shull. There are also products available for purchase that address this problem, such as the tree-lowering device sold under the name Portawrap by Sherrill Tree.

However, there are shortcomings in each of these inventions or products. For instance, the Portawrap product itself is not actually secured to the trunk of the tree. Rather, it is tied to a rope that encircles the tree. This leaves significant slack in the line that allows the tree limb to fall further than desired. The additional distance exponentially increases the speed of descent, which in turn significantly increases the stresses and forces on the rope.

Some of the patents identified above attempt to overcome this particular problem, but they do so by including spikes that must be driven into the trunk of the tree. This obviously causes damage to the tree, but also requires substantial effort to both set-up and remove it from the tree.

Thus, there remains a need for a load-handling device which can safely handle large loads and which does not move when once the limb has been cut, and which is also quick and easy to set-up and remove from the tree.

The present invention, as is detailed hereinbelow, seeks to fill this need by a providing a load-handing device for use by arborists in lowering tree limbs from a tree which has a plurality of non-penetrable teeth that frictionally engage the tree to keep the load-handling device firmly in place but also allow the device to be quickly and easily set-up and removed without causing damage to the tree.

### SUMMARY OF THE INVENTION

The present invention provides a load-handling device for lowering a limb from a tree, the limb being connected to a first end of a load-bearing line and the load-handling device being connected to a second end of the load-bearing line. The load-handling device has a plurality of teeth that frictionally engage but do not penetrate a trunk of the tree to keep the load-handling device from moving once the limb is cut from the tree and the load-bearing line applies a force to the load-handling device.

In a second aspect hereof the load-handling device for lowering a limb from a tree comprises: (a) a base including an elongated plate; (b) at least one cylindrical protuberance secured to the base; and (c) a plurality of non-penetrable teeth extending outward from the base in a first direction toward the trunk of the tree.

The device can include means for temporarily securing the device to the tree. In one embodiment, the means for temporarily securing the device includes at least one pair of opposed brackets connected to the base, and a strap having opposed ends for encircling a trunk or a limb of the tree, whereby each bracket is engageable with a respective end of the strap. The device can include at least one pair of opposed brackets, and in another embodiment hereof, it can have three pairs of opposed brackets.

Optionally, the plate has a first side and a second side, and a first row of the non-penetrable teeth extends from the first side, and a second row of the non-penetrable teeth extends from the second side.

Optionally, the cylindrical protuberance includes a retaining member for keeping a load-bearing line connected to the limb wrapped about the protuberance from slipping off an end of the protuberance. The retaining member can include a pair of opposed bars extending radially outwardly from the cylindrical protuberance.

According to another embodiment, there is provided a load-handling device for arborists for lowering tree limbs from a tree using a load-bearing line comprising: (a) a base; (b) means for temporarily securing the device to the tree; (c) means for frictionally-engaging the load-bearing line; and (d) a plurality of teeth protruding from the base to frictionally engage against, but not penetrate into, a trunk of the tree, whereby the plurality of teeth keep the load-handling device from moving when the load-bearing line applies a force to the load-handling device.

Optionally, the means for temporarily securing the device includes at least one pair of opposed brackets connected to the base.

As with the embodiment above, this embodiment also includes a plate having a first side and a second side, a first row of the non-penetrable teeth extends toward the tree from the first side, and a second row of the non-penetrable teeth extends toward the tree from the second side.

Optionally, the means for frictionally-engaging the load-bearing line can include at least one cylindrical protuberance secured to the base.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of a first embodiment of the present invention hereof;

FIG. 2 is a front view hereof;

FIG. 3 is a top view hereof;

FIG. 4 is a bottom perspective hereof;

FIG. 5 is an enlarged front view showing a plurality of teeth;

FIG. 6 is an environmental view showing the load-bearing line wrapped about the load-handling device; and

FIG. 7 is an environmental view showing the load-handling device is generally in use.

### DETAILED DESCRIPTION OF THE PREFERRED EMBODIMENT

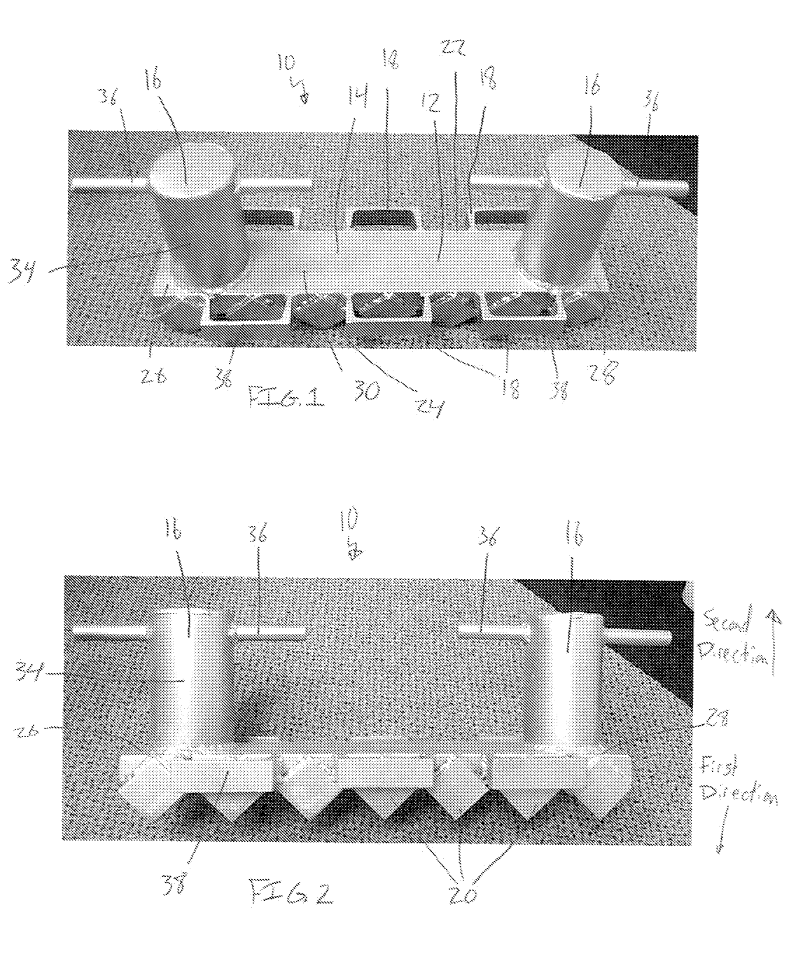

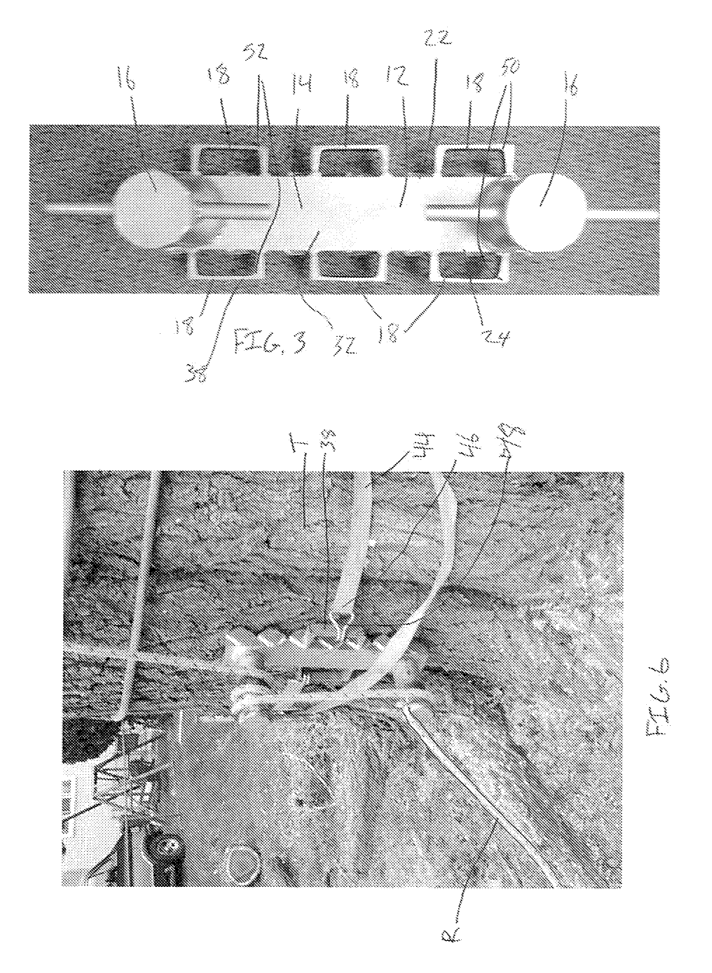

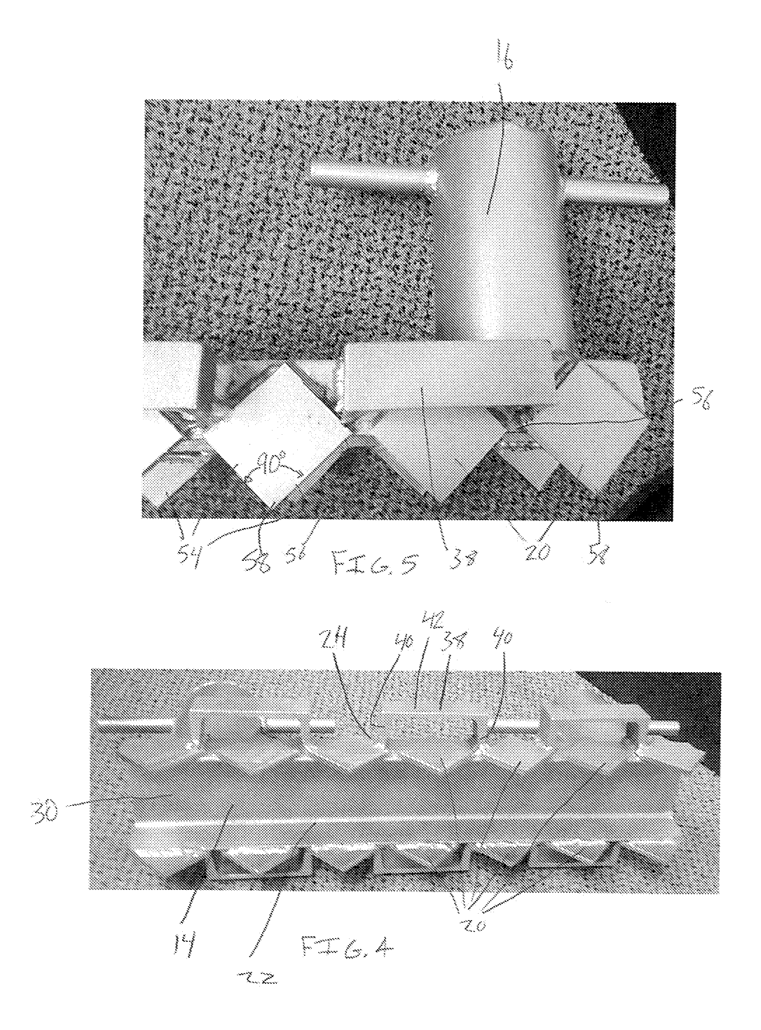

In accordance with the present invention and as shown generally in FIGS. 1-4, there is provided a load-handling device 10 for lowering a limb from a tree T comprising: (a) a base 12 including an elongated plate 14; (b) at least one cylindrical protuberance 16 secured to the base 12; (c) means for temporarily securing 18 the device 10 to the tree; and (d) a plurality of non-penetrable teeth 20 extending outward from the base 12 in a first direction toward the trunk of the tree.

At the onset, it is noted that the load-handling device 10 is intended for heavy-duty use in lowering tree limbs that can weigh several thousand pounds. As such, the load-handling device 10 is preferably formed from metal, and even more preferably from a high-strength metal such as steel. The various components and elements of the device 10 described hereinbelow are preferably assembled using a high-strength connection, such as by welding or bolting the components together.

The base 12 includes a plate 14 having a first side 22 and a second side 24, and a first end 26 and a second end 28. The plate 14 also has a first surface 30 and a second surface 32. The first surface 30 is oriented to face toward the tree in a first direction, while the second surface 32 is oriented to face away from the tree in a second direction.

There is also provided means for frictionally-engaging 34 the load-bearing line to the device 10. The means for frictionally-engaging 34 can include a cylinder member (such as the “cylindrical member 6” disclosed in U.S. Pat. No. 4,239,188 to Hobbs, the disclosure of which is hereby incorporated by reference), a protuberance (such as the “protuberance 54” disclosed in U.S. Pat. No. 6,631,885 to Halas, the disclosure of which is hereby incorporated by reference), or any other equivalent structure.

Preferably, the means for frictionally-engaging 34 the load-bearing line to the device 10 includes at least one cylindrical protuberance 16 secured to the base 12. Although the cylindrical protuberance 16 can be oriented in any suitable direction, such as shown in U.S. Pat. No. 6,631,885 to Halas, preferably the cylindrical protuberance 16 extends outwardly from the plate 14 in the second direction away from the tree. Although only one cylindrical protuberance 16 is required, there are preferably two protuberances 16 provided, as shown in the drawings. When two protuberances 16 are provided, each cylindrical protuberance 16 is positioned at a respective end of the plate 14.

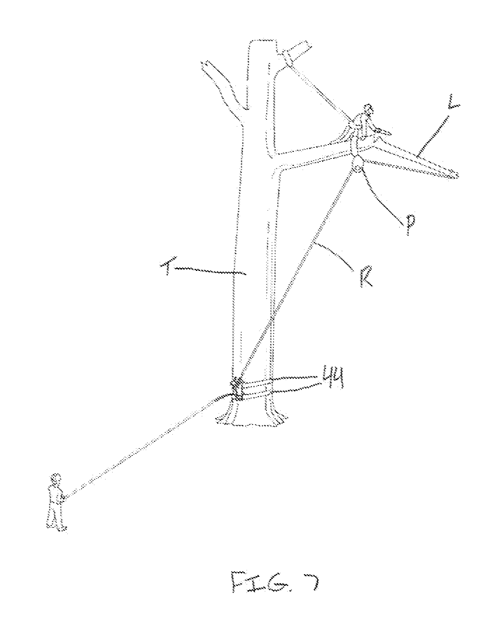

In use, and as shown in FIGS. 6 and 7, a rope R, or load-bearing line is connected to the tree limb L at one end and strung through a pulley P or similar device 10. The rope R is looped around the cylindrical protuberance(s) 16, and an operator holds onto the other end of the rope R. In order to lower the limb L, the operator slowly allows the rope R to be pulled through and around the protuberance(s) 16.

Optionally, the cylindrical protuberances 16 include a retaining member 36 for keeping the load-bearing line wrapped about the protuberance 16 so that the line does not slip off an end of the protuberance 16. Although the retaining member 36 can be any suitable type of structure, such as a flared disc, retention lip, flange, or the like, the retaining member 36 is preferably a pair of opposed bars extending radially outwardly from the cylindrical protuberance 16. As shown in FIG. 6, the line, or rope, can also loop around the retaining member 36 to direct the rope toward the operator.

The device 10 also includes means for temporarily securing 18 the device 10 to the tree. The means for temporarily securing 18 the device 10 can include a pair of hooks, a pair of eyelets for receiving hooks, a pair of brackets 38 having an opening for receiving a strap 44 or hook, or any other equivalent structure. The means for temporarily securing 18 the device 10 to the tree preferably comprises a pair of brackets 38, each bracket 38 has opposed ends 40 that connect to the base 12, and a medial portion 42 that loops between the ends 40, thereby forming an arch or similar structure having a void. A strap 44, chain, rope, or the like (hereinafter referred to as a “strap”) having opposed ends 46 is provided for encircling a trunk or a limb of the tree. Each bracket 38 is engageable with a respective end 46 of the strap 44. The strap 44 can have a closed loop extending around the brackets 38, a hook 48 for engaging the bracket 38, or the like.

The means for temporarily securing 18 the device 10 to the tree can include at least one pair of opposed brackets 38, and in another embodiment hereof, it can have three pairs of opposed brackets 38. When the limb being lowered is relatively small or medium in size, it may be suitable to only use a single strap 44 to secure the device 10 to the tree trunk. However, when the limb is large it can be beneficial to secure a strap 44 to the top 50 and bottom 52 pairs of the brackets 38 so that the device 10 does not twist or rotate once it is supporting the weight of the severed limb.

Furthermore, the device 10 includes a plurality of non-penetrable teeth 20 extending outward from the base 12 in the first direction toward the trunk of the tree. The non-penetrable teeth 20 frictionally engage against the bark of the tree, and will not allow the device 10 to move against the tree trunk once the device 10 has been secured to the tree and the limb has been severed. The non-penetrable teeth 20 include a series of peaks 54 and valleys 56 for engaging the coarse surface of the tree trunk. As shown in the embodiment in the drawings, the teeth 20 are each relatively thin and form points 58 that are approximately on 90° angles. The points 58 can be either greater than or less than 90° if desired. However, if the points 58 are 60° or less, the points 58 may be too sharp and may penetrate the bark of the tree. Likewise, if the points 58 are 120° or more, they may not be “sharp” enough to adequately engage the bark and resist movement of the device 10 with respect to the tree trunk. Therefore, the points 58 are preferably between 60° and 120°, and even more preferably the points 58 are about 90° as shown.

Although the teeth 20 are shown as being relatively thin in the drawings, the teeth 20 can comprise any suitable type of structure capable of frictionally engaging against the tree bark. For example the teeth 20 can be a plurality of pyramidal protuberances or any other suitable structure.

As referenced throughout, “non-penetrable” is intended to mean that the teeth 20 are not driven into the bark such that the device 10 remains implanted into the bark when the strap(s) 44 are removed. “Non-penetrable” is intended to encompass and include if the teeth 20 scratch the bark or minimally dig into it—depending upon the hardness of the bark and the species of tree. However, it is an intended purpose of the present invention that the device 10 can be set-up by simply being strapped to the tree and then used for its intended purpose. Upon completion, the strap(s) 44 is removed and the device 10 can simply fall from the side of the tree. Because the device 10 does not need to be driven into the trunk with a hammer or pried away from the trunk using a pry bar or other similar apparatus, the device 10 is much quicker and easier to set-up and remove than related devices in the prior art that include spikes that must be driven into the tree and then pried out of the tree after use.

Although it is possible that the device 10 may inflict some minimal damage to the bark, whatever minimal damage occurs is insignificant compared to driving a number of stakes into the trunk.

As is apparent from the preceding, the present invention provides a load-handing device for use by arborists in lowering tree limbs from a tree which has a plurality of non-penetrable teeth that frictionally engage the tree to keep the load-handling device firmly in place and safely allow for lowering of very heavy tree limbs, yet also allow the device to be quickly and easily set-up and removed without causing damage to the tree.

What is claimed is:

1. A load-handling device for lowering a limb from a tree comprising:
(a) a base including an elongated plate;
(b) at least one cylindrical protuberance secured to the base; and
(c) a plurality of non-penetrable teeth extending outward from the base in a first direction toward the trunk of the tree.

2. The device of claim 1 including means for temporarily securing the device to the tree.

3. The device of claim 2 wherein the means for temporarily securing the device includes at least one pair of opposed brackets connected to the base and a strap having opposed ends for encircling a trunk or a limb of the tree, each bracket being engageable with a respective end of the strap.

4. The device of claim 3 wherein the plate has a first side and a second side, and a first row of the non-penetrable teeth extends from the first side, and a second row of the non-penetrable teeth extends from the second side.

5. The device of claim 4 wherein the cylindrical protuberance includes a retaining member for keeping a load-bearing line connected to the limb wrapped about the protuberance from slipping off an end of the protuberance.

6. The device of claim 5 wherein the retaining member includes a pair of opposed bars extending radially outwardly from the cylindrical protuberance.

7. The device of claim 2 wherein the plate has a first side and a second side, and a first row of the non-penetrable teeth extends from the first side, and a second row of the non-penetrable teeth extends from the second side.

8. The device of claim 1 including at least one pair of opposed brackets.

9. The device of claim 8 having three pairs of opposed brackets.

10. The device of claim 9 wherein the plate has a first side and a second side, and a first row of the non-penetrable teeth extends from the first side, and a second row of the non-penetrable teeth extends from the second side.

11. The device of claim 8 wherein the plate has a first side and a second side, and a first row of the non-penetrable teeth extends from the first side, and a second row of the non-penetrable teeth extends from the second side.

12. The device of claim 11 wherein the cylindrical protuberance includes a retaining member for keeping a load-bearing line connected to the limb wrapped about the protuberance from slipping off an end of the protuberance.

13. The device of claim 12 wherein the retaining member includes a pair of opposed bars extending radially outwardly from the cylindrical protuberance.

14. The device of claim 1 wherein the plate has a first side and a second side, and a first row of the non-penetrable teeth extends from the first side, and a second row of the non-penetrable teeth extends from the second side.

15. A load-handling device for arborists for lowering tree limbs from a tree using a load-bearing line comprising:
(a) a base;
(b) means for temporarily securing the device to the tree;
(c) means for frictionally-engaging the load-bearing line; and
(d) a plurality of teeth protruding from the base to frictionally engage against, but not penetrate into, a trunk of the tree, whereby the plurality of teeth keep the load-handling device from moving when the load-bearing line applies a force to the load-handling device.

16. The device of claim 15 wherein the means for temporarily securing the device includes at least one pair of opposed brackets connected to the base.

17. The device of claim 16 wherein the base includes a plate having a first side and a second side, a first row of the non-penetrable teeth extends toward the tree from the first side, and a second row of the non-penetrable teeth extends toward the tree from the second side.

18. The device of claim 15 wherein the base includes a plate having a first side and a second side, a first row of the non-penetrable teeth extends toward the tree from the first side, and a second row of the non-penetrable teeth extends toward the tree from the second side.

19. The device of claim 15 wherein the means for frictionally-engaging the load-bearing line includes at least one cylindrical protuberance secured to the base.

20. A load-handling device for lowering a limb from a tree, the limb being connected to a first end of a load-bearing line and the load-handling device being connected to a second end of the load-bearing line, and the load-handling device having a plurality of teeth that frictionally engage but do not penetrate a trunk of the tree to keep the load-handling device from moving once the limb is cut from the tree and the load-bearing line applies a force to the load-handling device.
